(19) United States
(12) Patent Application Publication
(10) Pub. No.: US 2019/0243041 A1
(43) Pub. Date: Aug. 8, 2019

(54) PRESSURE SENSITIVE ADHESIVE-EQUIPPED POLARIZING PLATE

(71) Applicant: NITTO DENKO CORPORATION, Osaka (JP)

(72) Inventors: Shou TAKARADA, Osaka (JP); Yasutaka ISHIHARA, Osaka (JP); Minako NODA, Osaka (JP)

(73) Assignee: NITTO DENKO CORPORATION, Osaka (JP)

(21) Appl. No.: 16/269,952

(22) Filed: Feb. 7, 2019

(30) Foreign Application Priority Data
Feb. 8, 2018 (JP) 2018-020947

(51) Int. Cl. G02B 5/30; C09J 7/38; C09J 133/10

(52) U.S. Cl. CPC G02B 5/305; C09J 133/10; C09J 7/385

(57) ABSTRACT

Disclosed is a pressure sensitive adhesive-equipped polarizing plate (100) including a first pressure sensitive adhesive sheet arranged on one principal surface of a polarizing plate containing a polyvinyl alcohol-based polarizer. The polarizing plate includes a transparent protective film bonded to the second principal surface of the polarizer, and a urethane layer having a thickness of 0.1 to 10 μm disposed in contact with the first principal surface of the polarizer. The value XD² of the first pressure sensitive adhesive sheet disposed on the urethane layer is 1×10⁻⁷ g/24 h or more, where X is a water-vapor permeability of the pressure sensitive adhesive sheet, and D is a thickness of the pressure sensitive adhesive sheet.

### TECHNICAL FIELD

The present disclosure relates to a pressure sensitive adhesive-equipped polarizing plate used for an image display device.

### BACKGROUND ART

Liquid crystal (LC) displays and organic light emitting diode (OLED) displays are widely used as various kinds of image display devices of mobile phones, car navigation devices, personal computer monitors, televisions and so on. In an LC display, a polarizing plate is disposed on a viewing-side surface of an LC cell in accordance with the display principle. In an OLED display, a circularly polarizing plate (a laminate of a polarizing plate and a quarter wave plate) may be disposed on a viewing-side surface of an OLED cell for inhibiting external light reflection at a metal electrode (cathode) from being viewed like a mirror surface.

A polarizing plate generally has a configuration in which a transparent protective film is bonded to each of both surfaces of a polarizer formed of a polyvinyl alcohol-based film dyed with iodine or the like. A polarizing plate is also known in which a transparent protective film is disposed on only one surface of a polarizer in order to reduce the thickness and weight (e.g. JP 2017-58519 A). A pressure sensitive adhesive is used for fixing a polarizing plate to a surface of an image display cell.

In some cases, a transparent plate made of glass, resin, etc. is arranged on a viewing-side surface of an image display device, for the purpose of preventing damage to the image display panel due to impact from the outer surface. In an image display device including a touch panel, generally the touch panel is disposed on a viewing-side of an image display panel. When a front transparent member such as a front transparent plate (e.g., cover glass and cover window) and touch panel is disposed on a viewing-side, a polarizing plate arranged on a surface of an image display panel and the front transparent member are bonded to each other with a pressure sensitive adhesive interposed therebetween.

For formation of an image display device, a method is generally used in which a pressure sensitive adhesive-equipped polarizing plate in which a pressure sensitive adhesive sheet is laminated on a polarizing plate is bonded to a surface of an image display cell. When a front transparent member is disposed on a surface of an image display device, the front transparent member is bonded onto a polarizing plate with a pressure sensitive adhesive interposed therebetween. JP 2014-115468 A suggests a method using a both sides pressure sensitive adhesive-equipped polarizing plate for forming an image display device having a front transparent member. In the both sides pressure sensitive adhesive-equipped polarizing plate, a pressure sensitive adhesive sheet for bonding to an image display cell is disposed on one surface of a polarizing plate, and a pressure sensitive adhesive sheet for bonding to a front transparent member is disposed on the other surface of the polarizing plate.

### SUMMARY

A polarizing plate having a transparent protective film disposed on only one surface of a polarizer (hereinafter, sometimes referred to as a “single-side-protected polarizing plate”) is advantageous for reduction of the thickness and weight of an image display device. However, an image display device in which an image display cell is bonded to one surface of a single-side-protected polarizing plate and a front transparent member is bonded to the other surface of the single-side-protected polarizing plate has been found to easily suffer from reduction of the single transmittance of the polarizing plate and discoloration of a polarizer in the vicinity of the end surface of the polarizing plate and thus have a problem in durability as a result of a durability test at a high temperature and a high humidity. In view of the above it is required to provide a pressure sensitive adhesive-equipped polarizing plate which enables reduction in thickness and improvement in durability of an image display device.

Disclosed is a pressure sensitive adhesive-equipped polarizing plate including a pressure sensitive adhesive sheet on at least one principal surface of a polarizing plate containing a polyvinyl alcohol-based polarizer. The polarizer may be a thin polarizer having a thickness of 10 μm or less. The polarizing plate includes a transparent protective film bonded to one surface of the polarizer. No transparent protective film is provided on the other surface of the polarizer, and a urethane layer having a thickness of 0.1 to 10 μm is disposed in contact with the polarizer. Preferably, a first pressure sensitive adhesive sheet disposed on the urethane layer has high water-vapor permeability.

A single-side-protected polarizing plate includes a transparent protective film on only one surface of a polarizer. The pressure sensitive adhesive-equipped polarizing plate includes a pressure sensitive adhesive sheet with a high water-vapor permeability disposed on a polarizer with a urethane layer interposed therebetween. The urethane layer acts as a moisture permeation layer, so that dissipation of moisture in the polarizing plate from the end surface of the pressure sensitive adhesive sheet is promoted, and moisture entering from the outside is inhibited from being retained in the vicinity of the end surface. Thus, degradation of the polarizer, which is caused by moisture when an image display device is exposed to a high-temperature and high-humidity environment, is suppressed.

In the first pressure sensitive adhesive sheet, the product XD² of a water-vapor permeability X and the square of a thickness D is preferably 1×10⁻⁷ g/24 h or more. In the first pressure sensitive adhesive sheet, the product XD of the water-vapor permeability X and the thickness D is preferably 1×10⁻² g/m 24 h or more. As the pressure sensitive adhesive that forms the first pressure sensitive adhesive sheet, an acryl-based pressure sensitive adhesive containing an acryl-based polymer as a main component is preferably used. In the acryl-based polymer that forms the first pressure sensitive adhesive sheet, the amount of acid monomer components is preferably 1 part by weight or less based on 100 parts by weight of the total of constituent monomer components.

The pressure sensitive adhesive-equipped polarizing plate may include a second pressure sensitive adhesive sheet on a surface of the polarizing plate on which the transparent protective film is disposed. In a both sides pressure sensitive adhesive-equipped polarizing plate, which includes an pressure sensitive adhesive sheet on each of both a first principal surface and a second principal surface of a polarizing plate, one pressure sensitive adhesive sheet is used for bonding the polarizing plate to an image display cell, and the other pressure sensitive adhesive sheet is used for bonding the polarizing plate to a front transparent plate or touch panel.

In the both sides pressure sensitive adhesive-equipped polarizing plate, the thickness of the first pressure sensitive adhesive sheet and the thickness of the second pressure sensitive adhesive sheet may be identical to or different from each other. In a case where one pressure sensitive adhesive sheet is used for bonding the polarizing plate to an image display cell, and the other pressure sensitive adhesive sheet is used for bonding the polarizing plate to a front transparent plate or touch panel, it is preferable the thickness of the pressure sensitive adhesive sheet to be used for bonding the polarizing plate to the image display cell is relatively small.

### BRIEF DESCRIPTION OF THE DRAWINGS

FIG. 1 is a sectional view showing one embodiment of a configuration of a pressure sensitive adhesive-equipped polarizing plate.

FIG. 2 is a sectional view showing one embodiment of a configuration of a both sides pressure sensitive adhesive-equipped polarizing plate.

FIG. 3 is a sectional view schematically showing one embodiment of an image display device.

FIG. 4 is a sectional view showing one embodiment of a configuration of a both sides pressure sensitive adhesive-equipped polarizing plate.

FIG. 5 is a sectional view schematically showing one embodiment of an image display device.

### DETAILED DESCRIPTION OF EMBODIMENTS

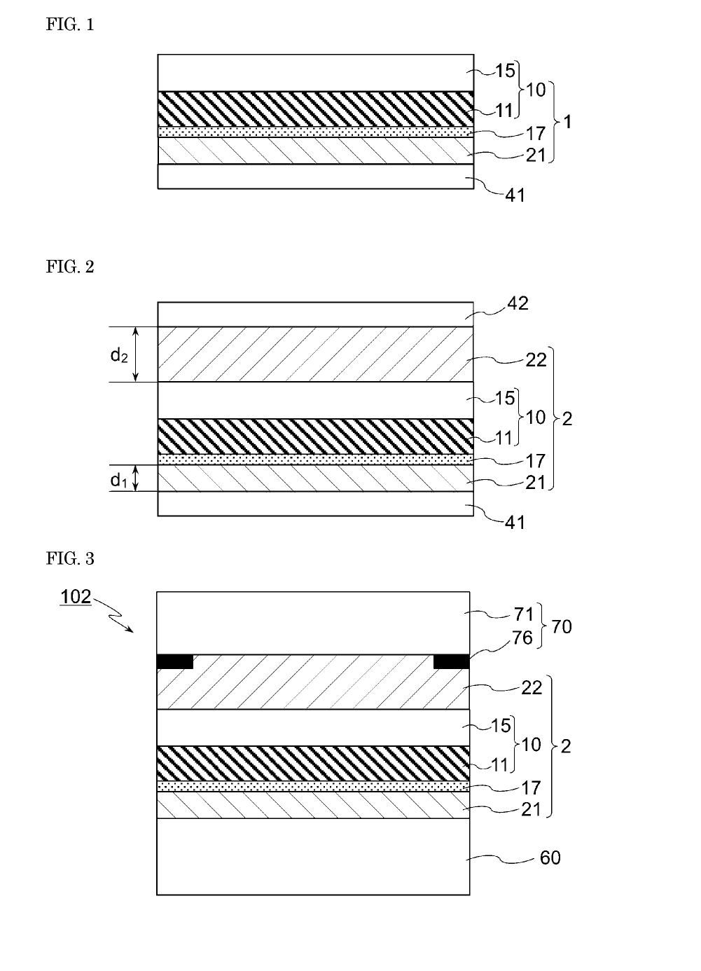

FIG. 1 is a sectional view showing an example of a configuration of a single-side pressure sensitive adhesive-equipped polarizing plate in which a pressure sensitive adhesive sheet 21 is disposed on one surface of a polarizing plate 10. A pressure sensitive adhesive-equipped polarizing plate 1 includes the pressure sensitive adhesive sheet 21 on a first principal surface of a polarizing plate 10. The pressure sensitive adhesive sheet 21 is used for bonding a polarizing plate to an image display cell, bonding a polarizing plate to a front transparent member (e.g., touch panel, or cover glass) in formation of an image display device.

The polarizing plate 10 includes a transparent protective film 15 on a second principal surface of the polarizer 11. On a first principal surface of the polarizer 11, a transparent protective film is not provided, and a urethane layer 17 is disposed in contact with the polarizer 11. The pressure sensitive adhesive sheet 21 is disposed in contact with the urethane layer 17. In other words, in the pressure sensitive adhesive-equipped polarizing plate 1, the polarizing plate 10 is a single-side-protected polarizing plate including the transparent protective film 15 on only the second principal surface of the polarizer 11, and the urethane layer 17 and the pressure sensitive adhesive sheet 21 are disposed on the first principal surface of the single-side-protected polarizing plate 10.

FIG. 2 is a sectional view showing an example of configuration of a both aides pressure sensitive adhesive-equipped polarizing plate. A both sides pressure sensitive adhesive-equipped polarizing plate 2 includes a first pressure sensitive adhesive sheet 21 on the first principal surface of the polarizing plate 10, and a second pressure sensitive adhesive sheet 22 on a second principal surface of the polarizing plate 10. FIG. 3 is a sectional view showing a configuration of an image display device prepared using the both sides pressure sensitive adhesive-equipped polarizing plate 2. In the image display device 102, the polarizing plate 10 is bonded to an image display cell 60 with the first pressure sensitive adhesive sheet 21 interposed therebetween, and the polarizing plate 10 is bonded to a front transparent member 70 with the second pressure sensitive adhesive sheet 22 interposed therebetween.

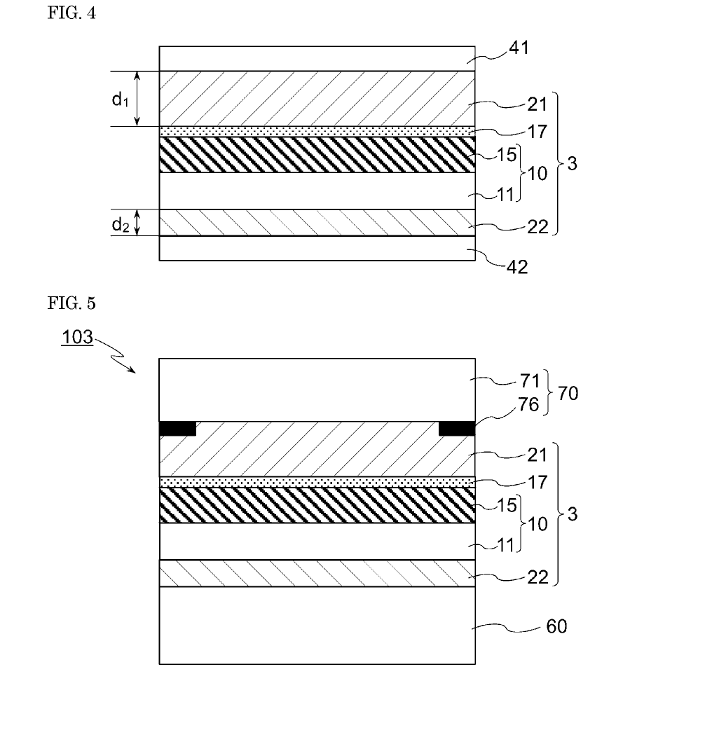

FIG. 4 is a sectional view showing another example of configuration of a both sides pressure sensitive adhesive-equipped polarizing plate. In the both sides pressure sensitive adhesive-equipped polarizing plate 2 in FIG. 4, a thickness d₁ of the first pressure sensitive adhesive sheet 21 is smaller than a thickness d₂ of the second pressure sensitive adhesive sheet, whereas in the both sides pressure sensitive adhesive-equipped polarizing plate 3 in FIG. 4, the thickness d₂ of the second pressure sensitive adhesive sheet 22 is smaller than the thickness d₁ of the first pressure sensitive adhesive sheet. FIG. 5 is a sectional view showing a configuration of an image display device prepared using the both sides pressure sensitive adhesive-equipped polarizing plate 3. In the image display device 103, the polarizing plate 10 is bonded to the front transparent member 70 with the first pressure sensitive adhesive sheet 21 interposed therebetween, and the polarizing plate 10 is bonded to the image display cell 60 with the second pressure sensitive adhesive sheet 22 interposed therebetween.

[Single-Side-Protected Polarizing Plate]

In the single-side-protected polarizing plate 10, the transparent protective film 15 is bonded to only one side of the polarizer 11. By using the single-side-protected polarizing plate, an image display device can be thinned.

<Polarizer>

The polarizer 11 is a polyvinyl alcohol (PVA)-based film containing a dichroic material such as iodine or a dichroic dye. As a material of the polyvinyl alcohol-based film to be used as the polarizer, polyvinyl alcohol or a derivative thereof is used. Examples of the derivative of polyvinyl alcohol include polyvinyl formal and polyvinyl acetal as well as polyvinyl alcohol modified with an olefin such as ethylene or propylene, an unsaturated carboxylic acid such as acrylic acid, methacrylic acid or crotonic acid, or an alkyl ester thereof, and an acryl amide. As the polyvinyl alcohol, one having a polymerization degree of about 1000 to 10000 and a saponification degree of about 80 to 100% by mol is generally used.

The polarizer can be obtained by dying and stretching the polyvinyl alcohol-based film. The thickness of the polarizer is, for example 1 to 50 μm. A thin polarizer having a thickness of 10 μm or less may also be used for the purpose of, e.g., thickness reduction of an image display device. Examples of the thin polarizer include thin polarizers as described in JP 51-069644 A, JP 2000-338329 A, WO 2010/100917, JP 4691205 B, JP 4751481 B, and so on. These thin polarizers are obtained by, for example, a production method including the steps of: stretching a laminate of polyvinyl alcohol-based resin layer and a stretchable resin base material; and performing iodine dying to the PVA-based resin layer. The thickness of the thin polarizer is preferably 1 to 10 μm, more preferably 2 to 8 μm, further preferably 3 to 7 μm from the viewpoint of attaining both thickness reduction and a high polarization degree.

<Transparent Protective Film>

The transparent protective film 15 for protecting the polarizer 11 is disposed on one surface (second principal surface) of the polarizer 11. The transparent protective film 15 may have an optical function such as an optical compensation film for wide viewing angle, etc., a quarter wave plate for forming a circular polarizing plate together with the polarizer 11.

The material that forms the transparent protective film 15 is, for example, a thermoplastic resin excellent in transparency, mechanical strength and heat stability. Specific examples of the thermoplastic resin include cellulose-based resins such as triacetyl cellulose, polyester-based resins, polyether sulfone-based resins, polysulfone-based resins, polycarbonate-based resins, polyamide-based resins, polyimide-based resins, polyolefin-based resins, (meth)acryl-based resin, cyclic polyolefin-based resins (norbornene-based resins), polyarylate-based resins, polystyrene-based resins, polyvinyl alcohol-based resins, and mixtures thereof.

A surface of the transparent protective film 15 may be provided with an antireflection layer, a hard coat layer, a sticking preventing layer, an easily adhesive layer and the like. For example, when a polarizing plate is disposed on the outermost surface of an image display device, scratch resistance can be imparted to the surface by providing a hard coat layer on a surface of the transparent protective film 15. On the other hand, when the front transparent member 70 is disposed on the viewing-side from the polarizing plate 10 as in the image display device shown in FIGS. 3 and 5, the transparent protective film 15 is not required to have scratch resistance. From the viewpoint of improving flexibility and suppressing generation of cracks, it is preferable that a hard coat layer is not provided on the surface of the transparent protective film 15.

Although the thickness of the transparent protective film 15 is not particularly limited, the thickness is preferably about 5 to 100 μm, more preferably 10 to 80 μm from the viewpoints of workability such as strength and handleability, thinness and the like. Preferably, the polarizer 11 is bonded to the transparent protective film 15 with an appropriate adhesive layer (not shown) interposed therebetween.

[Urethane Layer]

In the pressure sensitive adhesive-equipped polarizing plate, the urethane layer 17 is disposed in contact with the polarizer 11 on a surface (first principal surface) of the single-side-protected polarizing plate 10 on which the transparent protective film 15 is not provided, and the first pressure sensitive adhesive sheet 21 is disposed on the urethane layer 17. The urethane layer 17 acts as a permeable film which promotes movement of moisture.

The thickness of the urethane layer 17 is preferably smaller than the thickness of the transparent protective film 15. From the viewpoint of thinning, the thickness of the urethane layer 17 is preferably 10 μm or less, more preferably 5 μm or less, further preferably 2 μm or less, especially preferably 1 μm or less. On the other hand, from the viewpoint of imparting a function as a permeable film, the thickness of the urethane layer 17 is preferably 0.1 μm or more, more preferably 0.2 μm or more.

The urethane layer 17 contains a resin having a urethane bond. The urethane bond is typically formed by a reaction of a polyol and a polyisocyanate. The resin that forms the urethane layer 17 may contain an ester bond, an ether bond, an amide bond, a urea bond or the like in addition to a urethane bond. The urethane layer 17 is preferably a cured product layer of a urethane prepolymer.

The urethane prepolymer is generally formed by a reaction of a polyfunctional isocyanate (polyisocyanate) with a polyfunctional alcohol (polyol). The urethane prepolymer to be used for forming the urethane layer 17 is preferably an isocyanate-terminated urethane prepolymer. The isocyanate-terminated urethane prepolymer can form a polyurethane by reacting with a polyol. In the isocyanate of the isocyanate-terminated urethane prepolymer, an amine is generated by hydrolysis, and a urea bond is formed by a reaction of the amine with the isocyanate. Thus, the isocyanate-terminated urethane prepolymer alone may form a cured product.

The urethane prepolymer is obtained by, for example, reacting a polyisocyanate with a polyol. When the reaction is carried out at an equivalent ratio with excessive isocyanate groups, an isocyanate-terminated urethane prepolymer is obtained.

The polyisocyanate to be used for formation of the urethane prepolymer may be either an aromatic isocyanate or an alicyclic isocyanate. When the resin component of the urethane layer 17 has a rigid structure, the action of promoting movement of moisture tends to be high. Thus, it is preferable to use an aromatic polyisocyanate as the polyisocyanate.

Examples of the aromatic polyisocyanate include phenylene diisocyanate, 2,4-tolylene diisocyanate, 2,6-tolylene diisocyanate, 2,2′-diphenylmethane diisocyanate, 4,4′-diphenylmethane diisocyanate, 4,4′-toluidine diisocyanate, 4,4′-diphenyl ether diisocyanate, 4,4′-diphenyl diisocyanate, 1,5-naphthalene diisocyanate, xylylene diisocyanate, methylene bis-4-phenyl isocyanate, and p-phenylene diisocyanate. Among them, tolylene diisocyanate and diphenylmethane diisocyanate are preferable, and tolylene diisocyanate is especially preferable. The tolylene diisocyanate may be either 2,4-tolylene diisocyanate or 2,6-tolylene diisocyanate, or may be a mixture thereof.

Examples of the polyol to be used for forming the urethane prepolymer include ethylene glycol, diethylene glycol, 1,3-butanediol, 1,4-butanediol, neopentyl glycol, 3-methyl-1,5-pentanediol, 2-butyl-2-ethyl-1,3-propanediol, 2,4-diethyl-1,5-pentanediol, 1,2-hexanediol, 1,6-hexanediol, 1,8-octanediol, 1,9-nonane diol, 2-methyl-1,8-octanediol, 1,8-decanediol, octadecanediol, polyalkylene glycols, glycerin, trimethylolpropane, pentaerythritol and hexanetriol. Among these, from the viewpoint of introducing a rigid structure with a polymer network into a cured product, a tri-or-more-functional polyol is preferable, and trimethylolpropane is especially preferable.

In particular, the urethane prepolymer is preferably an isocyanate-terminated urethane prepolymer formed of a reaction product of an aromatic polyisocyanate with a tri-or-more-functional polyol, especially preferably an isocyanate-terminated urethane prepolymer formed of a reaction product of trimethylolpropane with tolylene diisocyanate.

The isocyanate-terminated urethane prepolymer may be one in which a protective group is added to a terminal isocyanate group. Examples of the protective group for the isocyanate include oxime and lactam. Since these protecting groups are desorbed from the isocyanate group by heating, the isocyanate group becomes reactive.

The urethane prepolymer is normally used as a solution of an organic solvent. In particular, since the isocyanate group has high reactivity with water, it is preferable that the isocyanate-terminated urethane prepolymer is used as a solution of an organic solvent from the viewpoint of storage stability. Examples of the organic solvent include toluene, methyl ethyl ketone and ethyl acetate.

A urethane layer-forming composition is applied to the first principal surface of the polarizer 11, and the solvent is removed to form the urethane layer 17. The urethane layer-forming composition contains a urethane prepolymer and a solvent. The urethane layer-forming composition may contain a compound having reactivity with the urethane prepolymer. For example, by using an isocyanate-terminated urethane prepolymer and a polyol, the isocyanate group of the prepolymer reacts with the polyol to form polyurethane. In addition, in the isocyanate-terminated urethane prepolymer, an amine generated by hydrolysis of the isocyanate group reacts with an isocyanate to form a urea bond, and therefore when an isocyanate-terminated urethane prepolymer is used alone, polyurethane polyurea is generated.

The drying temperature after application of the urethane layer-forming composition is, for example, about 30 to 100° C., preferably about 50 to 80° C. When the urethane layer-forming composition is cured, heating treatment (aging) may be performed at about 30 to 100° C., preferably 50 to 80° C., for about 0.5 to 24 hours in order to accelerate the curing reaction.

[First Pressure Sensitive Adhesive Sheet]

The first pressure sensitive adhesive sheet 21 disposed on the urethane layer 17 is used for bonding a polarizing plate to an image display cell, or bonding a polarizing plate to a front transparent member in formation of the image display device. For example, in the image display device 102 shown in FIG. 3, the polarizing plate 10 is bonded to the image display cell 60 by the first pressure sensitive adhesive sheet 21 disposed in contact with the urethane layer 17, and the polarizing plate 10 is bonded to the front transparent member 70 by the second pressure sensitive adhesive sheet 22 disposed on the transparent protective film 15. In the image display device 103 shown in FIG. 5, the polarizing plate 10 is bonded to the front transparent member 70 by the first pressure sensitive adhesive sheet 21, and the polarizing plate 10 is bonded to the image display cell 60 by the second pressure sensitive adhesive sheet 22.

Preferably, the first pressure sensitive adhesive sheet 21 on the urethane layer 17 has high transparency. The haze of the first pressure sensitive adhesive sheet 21 is preferably 1% or less, and the total light transmittance of the pressure sensitive adhesive sheet is preferably 90% or more. The haze and the total light transmittance are measured in accordance with JIS K7136 using a haze meter.

(Moisture Permeation Property of First Pressure Sensitive Adhesive Sheet)

In the first pressure sensitive adhesive sheet 21, the product XD (g/m·24 h) of the water-vapor permeability X and the thickness D is preferably 1×10⁻² or more. In the first pressure sensitive adhesive sheet 21, the product XD² (g/24 h) of the water-vapor permeability X and the square of the thickness D is preferably 1×10⁻⁷ or more. When the XD and XD² of the first pressure sensitive adhesive sheet on the urethane layer 17 are large, degradation of the polarizer in exposure of the image display device to a high-temperature and high-humidity environment is small, and durability tends to be improved.

When an image display device in which the image display cell 60 is bonded to one surface of the single-side-protected polarizing plate 10, and the front transparent member 70 is bonded to the other surface of the single-side-protected polarizing plate 10 is exposed to a high-temperature environment, the single transmittance of the polarizing plate may be reduced. One of factors of reducing the single transmittance of the polarizing plate is a phenomenon in which polyvinyl alcohol that forms the polarizer is formed into polyene (see, for example, JP 2014-102353 A). In a high-temperature environment, acid components remaining in the pressure sensitive adhesive and the transparent protective film are liberated by moisture to easily move into the polarizer. When heating is performed under a high humidity condition, a polymer that forms the pressure sensitive adhesive and residual monomers are hydrolyzed, so that free acid generation is facilitated. In the polyvinyl alcohol-based polarizer, the dehydration reaction of polyvinyl alcohol is catalyzed by free acids, so that a polyene structure (—(C═C)ₙ—) is easily formed. When the polyene structure is formed in the polyvinyl alcohol, the transmittance decreases.

Retention of moisture in the single-side-protected polarizing plate can be suppressed by disposing the urethane layer 17 acting as a moisture permeation layer on the polarizer 11, and disposing thereon the first pressure sensitive adhesive sheet 21 in which the product XD² of the water-vapor permeability X and the square of the thickness D is large. This may lead to suppression of a decrease in single transmittance of the polarizing plate due to polyene structure generation or the like in polyvinyl alcohol. The reason why generation of polyene structure in polyvinyl alcohol can be suppressed when the value XD² is large may be that moisture easily diffuses to the outside from the end surface of the pressure sensitive adhesive sheet 20, leading to suppression of retention of moisture in the pressure sensitive adhesive sheet.

A water-vapor permeability is the amount of moisture dissipated from the principal surface of a sheet-shaped material, and is used as an index of the amount of moisture dissipated to the outside through a sheet-shaped material such as a film or a pressure sensitive adhesive sheet. In an image display device in which a front transparent member and/or an image display cell is bonded to a polarizing plate with a pressure sensitive adhesive sheet interposed therebetween, moisture hardly dissipates from the principal surface, because movement of moisture to the outside is blocked by the front transparent member 70 even when the transparent protective film disposed on the polarizer 11 and the pressure sensitive adhesive sheet have a high water-vapor permeability.

The water-vapor permeability X is inversely proportional to the thickness D, and in sheet-shaped materials formed of the same material, the product XD of the water-vapor permeability and the thickness is almost constant. The value XD is an index indicating ease of movement (movement rate) of moisture in the material, and the movement rate of moisture in the pressure sensitive adhesive sheet 20 becomes higher as the value XD of the pressure sensitive adhesive sheet increases. The thickness D of the pressure sensitive adhesive sheet 20 is proportional to the area of the sheet end surface, and as the thickness D increases, moisture arriving at the end surface of the pressure sensitive adhesive sheet is more easily dissipated from the end surface to the outside of the system.

The value XD² is a product of the value XD that is related to ease of movement of moisture in the pressure sensitive adhesive sheet and the value D that is related to ease of dissipation of moisture from the end surface to the outside. Accordingly, as the value XD² increases, moisture is more easily dissipated from the end surface of the pressure sensitive adhesive sheet to the outside so that retention of moisture at the in-plane central portion of the pressure sensitive adhesive sheet tends to be suppressed.

As described above, the urethane layer 17 disposed in contact with the polarizer 11 of the single-side-protected polarizing plate 10 acts as a moisture permeation layer, and has an action of dissipating moisture in the polarizer 11 to the outside of the polarizer. Since the urethane layer 17 has a small thickness, the amount of moisture dissipated from the end surface of the urethane layer 17 is small, and moisture, which has moved from the polarizer 11 to the urethane layer 17, moves to the first pressure sensitive adhesive sheet 21 through the principal surface. When the value of XD² of the first pressure sensitive adhesive sheet 21 is large, moisture, which has moved from the polarizer 11 to the first pressure sensitive adhesive sheet 21 through the urethane layer 17, is easily dissipated from the end surface of the first pressure sensitive adhesive sheet 21 to the outside, so that reduction of the single transmittance due to formation of the polarizer into polyene can be suppressed.

The urethane layer 17 disposed in contact with the polarizer 11 acts as a permeation layer for dissipating moisture in the polarizer 11 to the outside, and has an action of allowing moisture from the outside to permeate through the polarizing plate in a high-humidity environment.

In the single-side-protected polarizing plate, the amount of moisture transferred to the polarizer 11 from the first principal surface (transparent protective film-free surface) is large. As described above, the product XD of the water-vapor permeability X and the thickness D of the pressure sensitive adhesive sheet is an index indicating ease of movement (movement rate) of moisture in the material, and the movement rate of moisture in the pressure sensitive adhesive sheet becomes higher as the value of XD increases.

Under a high humidity environment, moisture easily enters through the end surface of the first pressure sensitive adhesive sheet 21 from an outside environment at a relatively high humidity. Moisture, which has entered from the end surface of the pressure sensitive adhesive sheet, moves in the in-plane direction and the thickness direction of the pressure sensitive adhesive sheet. When the value of XD is small, moisture is easily retained in the vicinity of the end surface of the pressure sensitive adhesive sheet because the movement speed of moisture in the surface of the pressure sensitive adhesive sheet is small. When moisture retained in the vicinity of the end surface of the pressure sensitive adhesive sheet is transferred to the polarizer 11, discoloration easily occurs in the vicinity of the end surface of the polarizer. Discoloration of the polarizer in the vicinity of the end surface generated in exposure of the image display device to a high-humidity environment is ascribable principally to an increase in transmittance of visible light (blue light) having a short wavelength. Such discoloration easily occurs at the time when a complex of polyvinyl alcohol and an iodide ion (I₃⁻ and I₅⁻) is decomposed by heat and moisture. In particular, in a thin polarizer, the polarization degree is increased by impregnating a polyvinyl alcohol-based film with a dichroic substance such as iodine at a high concentration, and therefore an iodide ion complex is easily decomposed due to influences of moisture.

When the value of XD of the first pressure sensitive adhesive sheet 21 is large, the speed at which moisture entering from the end surface of the first pressure sensitive adhesive sheet 21 moves in the in-plane direction is high, and therefore the amount of moisture transferred to the polarizer 11 in the vicinity of the end surface decreases. In addition, the urethane layer 17 is disposed between the first pressure sensitive adhesive sheet 21 and the polarizer 11. The urethane layer 17 has an action of allowing moisture, which has been transferred from the pressure sensitive adhesive sheet 21, move in the in-plane direction. Therefore, retention of moisture in the vicinity of the end surface of the polarizer 11 is suppressed. Thus, when the first pressure sensitive adhesive sheet 21 having a large value of XD is disposed in contact with the urethane layer 17 on the polarizer 11, discoloration of the polarizer in the vicinity of the end surface due to ingress of moisture can be suppressed.

As described above, in the pressure sensitive adhesive-equipped polarizing plate, a first pressure sensitive adhesive sheet having a specific moisture permeation property is disposed, through the urethane layer 17 as a moisture permeation layer, on a protective film-free surface (first principal surface) of the single-side-protected polarizing plate 10. Thus, moisture in the polarizer 11 is easily released from the end surface of the first pressure sensitive adhesive sheet 21 to the outside, so that degradation of the polarizer due to retention of moisture in the in-plane central portion of the polarizing plate (e.g., reduction of the single transmittance of the polarizing plate due to formation of PVA into polyene) can be suppressed. In addition, moisture, which has entered from the end surface of the first pressure sensitive adhesive sheet 21, is easily uniformly diffused in the surface, and moisture is hardly retained in the vicinity of the end surface, so that degradation of the polarizer in the vicinity of the end surface (e.g., reduction of polarization degree due to discoloration) can be suppressed.

For suppressing moisture caused degradation of the polarizer, the value of XD² (g/24 h) of the first pressure sensitive adhesive sheet is more preferably 3×10⁻⁷ or more, further preferably 5×10⁻⁷ or more. From the same viewpoint as described above, the value of XD (g/m·24 h) of the first pressure sensitive adhesive sheet is more preferably 2×10⁻² or more, further preferably 3×10⁻² or more.

On the other hand, if the values of XD and XD² of the first pressure sensitive adhesive sheet 21 are excessively large, the amount of moisture entering the polarizer 11 from the end surface of the first pressure sensitive adhesive sheet 21 may increase in a high-temperature and high-humidity environment, leading to deterioration of durability. Accordingly, the value of XD² (g/24 h) of the first pressure sensitive adhesive sheet is preferably 3×10⁻⁵ or less, more preferably 2×10⁻⁵ or less, further preferably 1.5×10⁻⁵ or less. The value of XD (g/m·24 h) of the first pressure sensitive adhesive sheet is preferably 3×10⁻¹ or less, more preferably 2×10⁻¹ or less, further preferably 1.5×10⁻¹ or less.

For setting the values of XD and XD² within the above-mentioned ranges, respectively, the water-vapor permeability X (g/m²·24 h) of the first pressure sensitive adhesive sheet is preferably 100 to 10000, more preferably 200 to 8000, further preferably 300 to 6000, especially preferably 400 to 5000. The water-vapor permeability is a weight of water vapor permeating through a sample with an area of 1 m² in 24 hours at a relative humidity difference of 92% at 40° C., and is measured in accordance with the water-vapor permeability test (cup method) in JIS Z0208.

(Composition of Pressure Sensitive Adhesive Sheet)

The first pressure sensitive adhesive sheet 21 is formed of pressure sensitive adhesive. The pressure sensitive adhesive includes a base polymer such as an acryl-based polymer, a silicone-based polymer, polyester, polyurethane, polyamide, polyvinyl ether, a vinyl acetate/vinyl chloride copolymer, a modified polyolefin, an epoxy-based polymer, a fluorine-based polymer, a rubber-based polymer such as natural rubber or synthetic rubber, or the like. As a base polymer, an acryl-based pressure sensitive adhesive containing an acryl-based polymer is preferable because it is excellent in optical transparency and has a high water-vapor permeability.

The content of the acryl-based base polymer in the first pressure sensitive adhesive sheet 21 is preferably 50% by weight or more, more preferably 60% by weight or more. The acryl-based base polymer has (meth)acrylic acid alkyl ester monomer units as a main skeleton. In this specification, the “(meth)acryl” means acryl and/or methacryl. When the base polymer is a copolymer, the arrangement of constituent monomer units may be random or blockwise.

As the (meth)acrylic acid alkyl ester, a (meth)acrylic acid alkyl ester with the alkyl group having 1 to 20 carbon atoms is preferably used. Examples of the (meth)acrylic acid alkyl ester include methyl (meth)acrylate, ethyl (meth)acrylate, butyl (meth)acrylate, isobutyl (meth)acrylate, s-butyl (meth)acrylate, t-butyl (meth)acrylate, pentyl (meth)acrylate, isopentyl (meth)acrylate, neopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, isotridodecyl (meth)acrylate, tetradecyl (meth)acrylate, isotetradecyl (meth)acrylate, pentadecyl (meth)acrylate, cetyl (meth)acrylate, heptadecyl (meth)acrylate, octadecyl (meth)acrylate, isooctadecyl (meth)acrylate, nonadecyl (meth)acrylate and aralkyl (meth)acrylate.

The content of the (meth)acrylic acid alkyl ester is preferably 40% by weight or more, more preferably 50% by weight or more, further preferably 60% by weight or more based on the total amount of monomer components that form the base polymer.

The acryl-based base polymer may contain monomer units such as nitrogen-containing monomer units and hydroxy group-containing monomer units in addition to the (meth)acrylic acid alkyl ester. By including polar monomer units having nitrogen atoms or hydroxy groups, the adhesiveness of the pressure sensitive adhesive can be adjusted.

Examples of the nitrogen-containing monomer include N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, (meth)acryloylmorpholine, N-vinylcarboxylic acid amides and N-vinylcaprolactam.

As the hydroxy group-containing monomer, an alcoholic hydroxy group-containing (meth)acrylic acid ester, such as 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate and (4-hydroxymethylcyclohexyl)-methyl (meth)acrylate, is preferable.

When the acid component contained in the first pressure sensitive adhesive sheet is transferred to the polarizer, hydrolysis of the polyvinyl alcohol or formation of polyvinyl alcohol into polyene may be promoted, thus causing degradation of the polarizer. It is preferable the first pressure sensitive adhesive sheet 21 has a low content of organic acid monomers (free organic acids) such as (meth)acrylic acid. The content of (meth)acrylic acid monomers in the acryl-based pressure sensitive adhesive sheet is preferably 1000 ppm or less, more preferably 500 ppm or less, further preferably 100 ppm or less. The content of organic acid monomers in the pressure sensitive adhesive sheet is determined in the following manner: the pressure sensitive adhesive sheet is immersed in pure water, and heated at 100° C. for 45 minutes to extract acid monomers in the water, and the acid monomers are quantitatively determined by ion chromatography.

In a thermosetting polymer or a photocurable polymer, existence of unreacted residual monomers is unavoidable. Therefore, it is preferable that the amount of organic acid monomer components such as (meth)acrylic acid in monomer components that form the base polymer is decreased for reducing the content of acid monomers in the pressure sensitive adhesive sheet. The content of organic acid (carboxy group-containing monomer component) based on the total amount of constituent monomer components of the base polymer is preferably 5% by weight or less, more preferably 3% by weight or less, further preferably 1% by weight or less, particularly preferably 0.5% by weight or less.

The acryl-based polymer can be prepared by polymerizing the above-mentioned monomer components by a common polymerization method. Examples of the method for polymerization of an acryl-based polymer include solution polymerization methods, emulsion polymerization methods, mass polymerization methods, and polymerization by irradiation of an active energy ray (active energy ray polymerization methods). Solution polymerization methods or active energy ray polymerization methods are preferable from the viewpoint of transparency, water resistance, costs and so on.

In preparation of the base polymer, a polymerization initiator such as a photopolymerization initiator or a thermopolymerization initiator may be used depending on a type of polymerization reaction. Polymerization initiators may be used alone, or in combination of two or more thereof. The molecular weight of the base polymer is appropriately adjusted. The polystyrene-equivalent weight average molecular weight of the base polymer is preferably 50000 to 2000000, more preferably 100000 to 1500000 so that the pressure sensitive adhesive sheet may have moderate viscoelasticity and adhesiveness.

The base polymer may have a crosslinked structure as necessary. The crosslinked structure is formed by, for example, adding a crosslinker after polymerization of the base polymer. As the crosslinker, a common cross linker can be used, such as an isocyanate-based crosslinker, an epoxy-based crosslinker, an oxazoline-based crosslinker, an aziridine-based crosslinker, a carbodiimide-based crosslinker or a metal chelate-based crosslinker. T The content of the crosslinker is normally 10 parts by weight or less, preferably 5 parts by weight or less, further preferably 3 parts by weight or less based on 100 parts by weight of the base polymer.

When the pressure sensitive adhesive composition includes a crosslinker, it is preferred to perform a heating for crosslinking to form crosslinked structure before bonding to an adherend. The heating temperature and the heating time in the crosslinking treatment are appropriately set according to a type of crosslinker to be used, and crosslinking is normally performed by heating at 20° C. to 160° C. for 1 minute to about 7 days.

Besides the aforementioned acryl-based polymer, the pressure sensitive adhesive composition may contain a silicone-based polymer, a polyester, a polyurethane, a polyamide, a polyvinyl ether, a vinyl acetate/vinyl chloride copolymer, a modified polyolefin, an epoxy-based polymer, a fluorine-based polymer, or a polymer based on a rubber such as a natural rubber or a synthetic rubber, or the like.

For the purpose of adjusting the adhesive strength, a silane coupling agent can also be added in the pressure sensitive adhesive composition. The silane coupling agent may be used by one kind singly or two or more kinds in combination. When the pressure sensitive adhesive composition includes a silane coupling agent, the content thereof is normally about 0.01 to 5.0 parts by weight, preferably 0.03 to 2.0 parts by weight based on 100 parts by weight of the polymer in the pressure sensitive adhesive.

The pressure sensitive adhesive composition may contain a tackifier as necessary. As the tackifier, for example, a terpene-based tackifier, a styrene-based tackifier, a phenol-based tackifier, a rosin-based tackifier, an epoxy-based tackifier, a dicyclopentadiene-based tackifier, a polyamide-based tackifier, a ketone-based tackifier, an elastomer-based tackifier or the like can be used.

The first pressure sensitive adhesive sheet 21 may contain an ultraviolet absorber. In particular, when the front transparent member 70 is bonded to the first principal surface of the single-side-protected polarizing plate 10 through the first pressure sensitive adhesive sheet 21 as in the image display device 103 shown in FIG. 5, it is preferable that the first pressure sensitive adhesive sheet 21 contains an ultraviolet absorber. Generally, the transparent protective film disposed on the viewing-side surface of the polarizer contains an ultraviolet absorber for the purpose of preventing degradation of the polarizer which is caused by an ultraviolet ray. In the single-side-protected polarizing plate 10 having no transparent protective film on the viewing-side of the polarizer 11, the transparent protective film is not provided on a first pressure sensitive adhesive sheet 21-equipped surface. Therefore, it is preferable that an ultraviolet absorption property is imparted to the first pressure sensitive adhesive sheet 21 to prevent ultraviolet ray-caused degradation of the polarizer 11.

Examples of the ultraviolet absorber include benzophenone-based ultraviolet absorbers, benzotriazole-based ultraviolet absorbers, salicylic acid-based ultraviolet absorbers, oxalic acid anilide-based ultraviolet absorbers, cyanoacrylate-based ultraviolet absorbers and triazine-based ultraviolet absorbers. The content of the ultraviolet absorber is preferably 0.01 to 15 parts by weight, more preferably 0.1 to 10 parts by weight based on 100 parts by weight of the polymer of the pressure sensitive adhesive. When the first pressure sensitive adhesive sheet 21 is used for bonding to the front transparent member 70, the light transmittance of the first pressure sensitive adhesive sheet 21 at a wavelength of 380 nm is preferably 15% or less, more preferably 10% or less.

In addition to each of the components shown above as examples, additives such as a plasticizer, a softener, a degradation preventing agent, a filler, a colorant, an antioxidant, a surfactant and an antistatic agent can be used in the pressure sensitive adhesive that forms the pressure sensitive adhesive sheet within the bounds of not impairing the properties of the pressure sensitive adhesive.

The pressure sensitive adhesive that forms the first pressure sensitive adhesive sheet 21 may be a photocurable or thermosetting pressure sensitive adhesive. For example, when the first pressure sensitive adhesive sheet 21 before curing is used for bonding the polarizing plate 10 to the front transparent member 70 in formation of the image display device 103 shown in FIG. 5, problems such as ingress of air bubbles in the vicinity of a printing level difference can be suppressed because the pressure sensitive adhesive has high fluidity and excellent flexibility. When the pressure sensitive adhesive is cured after bonding, bonding reliability is improved. A photocurable pressure sensitive adhesive is preferable from the viewpoint of control of timing of curing, reliability and so on.

The photocurable pressure sensitive adhesive contains a photocurable component. As the photocurable component, a radical-polymerizable compound (ethylenically unsaturated compound) having a carbon-carbon double bond (C═C bond) is preferably used. The radical-polymerizable compound may be present as a monomer or oligomer in the pressure sensitive adhesive composition, or may be bonded to a functional group such as a hydroxy group of the base polymer. The curable pressure sensitive adhesive is preferably one containing a polymerization initiator (photopolymerization initiator or thermopolymerization initiator).

When the radical-polymerizable compound is present as a monomer or oligomer in the pressure sensitive adhesive composition, a polyfunctional polymerizable compound having two or more polymerizable functional groups in one molecule is preferably used. Examples of the polyfunctional polymerizable compound include compounds having two or more C═C bonds per molecule, and compounds having one C═C bond and a polymerizable functional group such as epoxy, aziridine, oxazoline, hydrazine or methylol. Among them, a polyfunctional polymerizable compounds having two or more C═C bonds per molecule, such as polyfunctional acrylates, are preferable.

[Preparation of Pressure Sensitive Adhesive Sheet]

Various kinds of coating methods are applicable for formation of the pressure sensitive adhesive sheet. Specific examples include roll coating, kiss roll coating, gravure coating, reverse coating, roll brushing, spray coating, dip roll coating, bar coating, knife coating, air knife coating, curtain coating, lip coating, and extrusion coating methods using a die coater, etc.

When the base polymer in the pressure sensitive adhesive composition is a solution polymerized polymer, it is preferable to perform drying the solvent after applying the pressure sensitive adhesive composition. Any suitable drying method can be appropriately employed according to a purpose. The heating/drying temperature is preferably 40° C. to 200° C., more preferably 50° C. to 180° C., further preferably 70° C. to 170° C. Suitable drying time can be appropriately employed. The drying time is preferably 5 seconds to 20 minutes, more preferably 5 seconds to 15 minutes, further preferably 10 seconds to 10 minutes.

When the pressure sensitive adhesive composition includes a crosslinker, a heating for crosslinking may be performed after the pressure sensitive adhesive composition is applied on the substrate. The heating temperature and the heating time are appropriately set according to a type of crosslinker to be used, and crosslinking is normally performed by heating at 20° C. to 160° C. for 1 minute to about 7 days. Heating for drying the pressure sensitive adhesive after application may serve may also serve as heating for crosslinking.

Preferably, the protective sheet 41 is releasably attached onto the first pressure sensitive adhesive sheet 21 of the pressure sensitive adhesive-equipped polarizing plate 1 as shown in FIG. 1. The protective sheet is provided for protecting the exposed surface of the pressure sensitive adhesive, until the pressure sensitive adhesive is bonded to adherend. A substrate used for formation (application) of the pressure sensitive adhesive sheet may be used as it is as a protective sheet 41

As the protective sheet 41, a plastic film made of polyethylene, polypropylene, polyethylene terephthalate, polyester, or the like is preferably used. The thickness of each of the protective sheets is normally 5 to 200 μm, preferably about 10 to 150 μm. The protective sheet may be subjected to release and antifouling treatments with a silicone-based, fluorine-based, long-chain alkyl-based or fatty acid amide-based releasing agent, a silica powder or the like, and an antistatic treatment of coating type, kneading type, vapor deposition type or the like. Particularly, by appropriately subjecting the surface of the protective sheet to a release treatment with using silicone, long-chain alkyl, fluorine or the like, releasability from the pressure sensitive adhesive sheets can be further improved.

The thickness of the first pressure sensitive adhesive sheet 21 is not particularly limited. For setting the values of XD and XD² within the above-described ranges, respectively, the thickness of the first pressure sensitive adhesive sheet 21 is preferably 5 μm or more, more preferably 10 μm or more. When the first pressure sensitive adhesive sheet 21 is used for bonding the polarizing plate 10 to the image display cell 60 as shown in FIG. 3, the thickness of the first pressure sensitive adhesive sheet 21 is preferably 30 μm or less, more preferably 25 μm or less from the viewpoint of thinning of the image display device. On the other hand, when the first pressure sensitive adhesive sheet 21 has a level difference portion such as a decorative printed portion 76 as shown in FIG. 5, the thickness of the first pressure sensitive adhesive sheet 21 is preferably 30 to 500 μm, more preferably 50 to 300 μm for imparting a level difference absorbability.

[Second Pressure Sensitive Adhesive Sheet]

By disposing the first pressure sensitive adhesive sheet 21 on the first principal surface of the single-side-protected polarizing plate 10 with the urethane layer 17 interposed therebetween, and disposing the second pressure sensitive adhesive sheet 22 on the second principal surface (surface equipped with the transparent protective film 15), a both sides pressure sensitive adhesive-equipped polarizing plate is obtained. In the both sides pressure sensitive adhesive-equipped polarizing plate, a first protective sheet 41 may be releasably attached onto the first pressure sensitive adhesive sheet 21, and a second protective sheet 42 may be releasably attached onto the second pressure sensitive adhesive sheet 22 as shown in FIGS. 2 and 4.

By using a both sides pressure sensitive adhesive-equipped polarizing plate in which a pressure sensitive adhesive sheet is disposed on each of both surfaces of the polarizing plate 10 in advance, a step of disposing an additional pressure sensitive adhesive sheet on the polarizing plate at the time of bonding a front transparent member onto the polarizing plate after bonding the polarizing plate to a surface of an image display cell can be omitted, so that the process for producing an image display device can be simplified.

The single-side-protected polarizing plate has a smaller thickness and lower strength as compared to a polarizing plate including a transparent protective film on each of both surfaces of a polarizer. Thus, at the time of rework operation (operation in which a polarizing plate is peeled off from a defective product, etc. after the polarizing plate is bonded to an image display cell with the pressure sensitive adhesive sheet interposed therebetween), the single-side-protected polarizing plate is easily torn, and in particular, a single-side-protected polarizing plate having a thin polarizer has low rework operability, in general. The both sides pressure sensitive adhesive-equipped polarizing plate includes a pressure sensitive adhesive sheet disposed on each of both surfaces of the single-side-protected polarizing plate 10. In rework operation after bonding of the polarizing plate to the image display cell with one pressure sensitive adhesive sheet interposed therebetween, the other pressure sensitive adhesive sheet can have an action of preventing the single-side-protected polarizing plate from being torn. Thus, by disposing a pressure sensitive adhesive sheet on each of both surfaces of the single-side-protected polarizing plate, rework operability can be improved even when a thin polarizer is used.

The second pressure sensitive adhesive sheet 22 is used for bonding the polarizing plate to the image display cell or bonding the polarizing plate to the front transparent member in formation of the image display device. When the first pressure sensitive adhesive sheet is used for bonding the polarizing plate 10 to the image display cell 60, the second pressure sensitive adhesive sheet 22 is used for bonding the polarizing plate 10 to the front transparent member 70. When the first pressure sensitive adhesive sheet is used for bonding the polarizing plate 10 to the front transparent member 70, the second pressure sensitive adhesive sheet 22 is used for bonding the polarizing plate 10 to the image display cell 60.

Preferably, the second pressure sensitive adhesive sheet 22 has high transparency. The haze of the second pressure sensitive adhesive sheet 22 is preferably 1% or less, and the total light transmittance of the pressure sensitive adhesive sheet is preferably 90% or more. The pressure sensitive adhesive that forms the second pressure sensitive adhesive sheet 22 is not particularly limited, and various polymers can be used as in the case of the first pressure sensitive adhesive sheet 21. In particular, an acryl-based pressure sensitive adhesive containing an acryl-based polymer as a base polymer is preferable because it is excellent in optical transparency.

In the single-side-protected polarizing plate 10, the amount of moisture entering the polarizer from a surface on which the transparent protective film 15 is not provided, and the amount of moisture dissipated from the polarizer are relatively large. The water-vapor permeability of the second pressure sensitive adhesive sheet 22 that is disposed on the transparent protective film 15 is not particularly limited because it does not considerably influence moisture-caused degradation of the polarizer.

The composition of the pressure sensitive adhesive that forms the second pressure sensitive adhesive sheet may be appropriately set according to the type of an adherend, etc. When the front transparent member 70 is bonded to the first principal surface of the single-side-protected polarizing plate 10 with the second pressure sensitive adhesive sheet 22 interposed therebetween as shown in FIG. 3, it is preferable that the second pressure sensitive adhesive sheet 22 contains an ultraviolet absorber.

The thickness d₂ of the second pressure sensitive adhesive sheet 22 is not particularly limited, and may be equal to or different from the thickness d₁ of the first pressure sensitive adhesive sheet 21. When the second pressure sensitive adhesive sheet 22 has a level difference portion such as a decorative printed portion 76 as shown in FIG. 3, the thickness of the second pressure sensitive adhesive sheet 22 is preferably 30 to 500 μm, more preferably 50 to 300 μm for imparting a level difference absorbability. On the other hand, when the second pressure sensitive adhesive sheet 22 is used for bonding the polarizing plate 10 to the image display cell as shown in FIG. 5, the thickness of the second pressure sensitive adhesive sheet 22 is preferably 30 μm or less, more preferably 25 μm or less from the viewpoint of thinning of the image display device.

It is preferable that the pressure sensitive adhesive sheet to be used for bonding to the image display cell 60 (cell-side pressure sensitive adhesive sheet) has a thickness smaller than the thickness of the pressure sensitive adhesive sheet to be used for bonding to the front transparent member 70 (viewing-side pressure sensitive adhesive sheet). The image display device can be thinned by reducing the thickness of the cell-side pressure sensitive adhesive sheet, and a level difference absorbability can be imparted by relatively increasing the thickness of the viewing-side pressure sensitive adhesive sheet.

[Image Display Device]

The pressure sensitive adhesive-equipped polarizing plate can be used for forming an image display device. The image display device can be formed by, for example, bonding the single-side pressure sensitive adhesive-equipped polarizing plate 1 on one side as shown in FIG. 1 to the image display cell with the first pressure sensitive adhesive sheet 21 interposed therebetween. In addition, after the single-side pressure sensitive adhesive-equipped polarizing plate 1 is bonded onto the image display cell, a cover glass, etc. may be bonded thereto with another pressure sensitive adhesive sheet interposed therebetween.

For forming an image display device including the front transparent member 70 such as a touch panel or front transparent plate on the viewing-side surface of an image display panel, it is preferable to use the both sides pressure sensitive adhesive-equipped polarizing plate as shown in FIGS. 2 and 4. As described above, use of a both sides pressure sensitive adhesive-equipped polarizing plate makes it possible to simplify the process for producing an image display device, and improves rework operability.

Examples of the front transparent member 70 includes a front transparent plate (window layer) and a touch panel. As the front transparent plate, a transparent plate having appropriate mechanical strength and thickness. As this transparent plate, for example, a transparent resin plate such as that of an acryl-based resin or a polycarbonate-based resin, or a glass plate is used. As the touch panel, a touch panel of any type such as resistive film type, capacitance type, optical type or ultrasonic type is used.

The method for bonding the image display cell 60 and the polarizing plate 10 and the method for bonding the front transparent member 70 and the polarizing plate 10 are not particularly limited. The bonding can be performed by various kinds of known methods, after the protective sheets 41 and 42 attached on the surfaces of the pressure sensitive adhesive sheets 21 and 22, respectively, are peeled off.

For improving workability in bonding and axis precision of the polarizing plate, a method is preferable in which bonding of the polarizing plate 10 and the image display cell 60 to each other is performed after peeling off the protective sheet from the surface of the cell-side pressure sensitive adhesive sheet is performed, followed by peeling off the protective sheet from the surface of the viewing-side pressure sensitive adhesive sheet, and thereafter bonding the polarizing optical film 10 and the front transparent member 70 to each other.

When the front transparent member 70 has a level difference portion such as the decorative printed portion 76 on the transparent plate 71, it is preferable that defoaming is performed for removing air bubbles at an interface between the pressure sensitive adhesive sheet and the front transparent member 70 and in the vicinity of the level difference portion. As a defoaming method, an appropriate method such as heating, pressurization or pressure reduction can be employed. For example, it is preferred that bonding is performed while ingress of bubbles is suppressed under reduced pressure and heating, and pressurization is then performed in parallel with heating through autoclave or the like for the purpose of, for example, suppressing delay bubbles.

When the viewing-side pressure sensitive adhesive sheet contains a photocurable or thermosetting pressure sensitive adhesive, it is preferable that curing is performed after the polarizing plate 10 is bonded to the front transparent member 70. By curing the pressure sensitive adhesive, reliability of bonding of the polarizing plate 10 to the front transparent member 70 can be improved. The method for curing the pressure sensitive adhesive is not particularly limited. When photocuring is performed, a method is preferable in which an active ray such as an ultraviolet ray is applied through the front transparent member 70.

### EXAMPLE

Examples and comparative examples are shown below, but the present invention is not limited to these examples.

[Evaluation]

<Water-Vapor Permeability>

Water-vapor permeation test was performed in thermohygrostat bath at 40° C. and a relative humidity of 92% for 24 hours, and the water-vapor permeability was calculated in accordance with the water-vapor permeability test (cup method) in JIS Z0208.

<Ultraviolet Transmittance>

The transmittance spectrum was measured by a UV-visible spectrophotometer, and the transmittance at a wavelength of 380 nm was read.

[Preparation of Pressure Sensitive Adhesive Sheet]

<Pressure Sensitive Adhesive Sheet A>

(Preparation of Pressure Sensitive Adhesive Composition)

80 parts by weight of butyl acrylate (BA), 0.2 parts by weight of acrylic acid (AA), 16 parts by weight of phenoxyethyl acrylate (PEA), 0.8 parts by weight of 4-hydroxybutyl acrylate (4HBA) and 3 parts by weight of N-vinylpyrrolidone (NVP) as monomer components, and 0.2 parts by weight of azobisisobutyronitrile (AIBN) as a thermopolymerization initiator were put in a reaction vessel along with 233 parts by weight of ethyl acetate, and the mixture was stirred under a nitrogen atmosphere at 23° C. for 1 hour to purge the mixture with nitrogen. Thereafter, the mixture was reacted at 60° C. for 5 hours to obtain a solution of an acrylic base polymer having a weight average molecular weight (Mw) of U.S. Pat. No. 1,100,000. To this acrylic base polymer solution were added 0.3 parts by weight of a trimethylolpropane adduct of xylylene diisocyanate (“TAKENATE D110N” manufactured by Mitsui Chemicals, Incorporated) as an isocyanate-based crosslinker and 0.1 parts by weight of 3-glycidoxypropyltrimethoxysilane (“KBM 403” manufactured by Shin-Etsu Chemical Co., Ltd.) as a silane coupling agent, and the mixture was then uniformly mixed to prepare a pressure sensitive adhesive composition solution.

(Preparation of Pressure Sensitive Adhesive Sheet)

The pressure sensitive adhesive composition was applied to a release-treated surface of a separator (a polyester film subjected to release treatment on one side with silicone) so as to have a thickness of 20 μm after drying, and dried at 100° C. for 3 minutes to remove the solvent, thereby obtaining a pressure sensitive adhesive sheet. Thereafter, the pressure sensitive adhesive sheet was heated at 50° C. for 48 hours to perform crosslinking treatment, thereby obtaining a pressure sensitive adhesive sheet A.

<Pressure Sensitive Adhesive Sheet B>

A pressure sensitive adhesive composition solution was prepared in the same manner as in the case of the pressure sensitive adhesive sheet A except that the monomer components were changed to 95 parts by weight of BA and 5 parts by weight of AA. The pressure sensitive adhesive composition solution was applied onto a separator, dried and crosslinked to obtain a pressure sensitive adhesive sheet B having a thickness of 20 μm.

<Pressure Sensitive Adhesive Sheet C>

A pressure sensitive adhesive composition solution was prepared in the same manner as in the case of the pressure sensitive adhesive sheet A except that the monomer components were changed to 22 parts by weight of 2-ethylhexyl acrylate (2EHA), 62 parts by weight of lauryl acrylate (LA), 8 parts by weight of 4HBA and 10 parts by weight of NVP. The pressure sensitive adhesive composition solution was applied onto a separator, dried and crosslinked to obtain a pressure sensitive adhesive sheet C having a thickness of 20 μm.

<Pressure Sensitive Adhesive Sheet D>

100 parts by weight of polyisobutylene (PIB; “OPPANOL B80” manufactured by BASF SE) having a weight average molecular weight of about 750,000 was mixed with 300 parts by weight of toluene to prepare a pressure sensitive adhesive composition. The pressure sensitive adhesive composition was applied to a release-treated surface of a separator so as to have a thickness of 20 μm after drying, and dried at 130° C. for 2 minutes to remove the solvent, thereby obtaining a pressure sensitive adhesive sheet D.

<Pressure Sensitive Adhesive Sheet K>

(Preparation of Pressure Sensitive Adhesive Composition)

67 parts by weight of 2-ethylhexyl acrylate (2EHA), 15 parts by weight of NVP, 1 part by weight of hydroxyethyl acrylate (HEA), and 0.1 parts by weight of 1-hydroxy-cyclohexyl-phenyl-ketone (“IRGACURE 184” manufactured by BASF SE) as a photopolymerization initiator were put in a reaction vessel, and the mixture was irradiated with an ultraviolet ray under a nitrogen atmosphere to obtain a prepolymer composition with a polymerization ratio of 10%. To 100 parts by weight of the prepolymer composition were added 0.2 parts by weight of 2,2-dimethoxy-1,2-diphenylethane-1-one (“IRGACURE 651” manufactured by BASF SE) as a photopolymerization initiator, 0.2 parts by weight of trimethylolpropane triacrylate (TMPTA) as a polyfunctional monomer, and 0.3 parts by weight of a silane coupling agent (“KBM 403” manufactured by Shin-Etsu Chemical Co., Ltd.), and the mixture was then uniformly mixed to prepare a pressure sensitive adhesive composition.

(Preparation of Pressure Sensitive Adhesive Sheet)

The pressure sensitive adhesive composition was applied to a release-treated surface of a separator with a thickness of 100 μm, and the release-treated surface of another separator was bonded onto the coating layer. Thereafter, by a black light, which was position-adjusted so that the irradiation intensity at an irradiation surface just below the lamp was 5 mW/cm², UV irradiation was performed until the integrated light amount reached 3000 mJ/cm², so that polymerization was advanced to obtain a pressure sensitive adhesive sheet K.

<Pressure Sensitive Adhesive Sheet L>

A pressure sensitive adhesive composition solution was prepared in the same manner as in the case of the pressure sensitive adhesive sheet K except that to 100 parts by weight of a prepolymer composition were added 0.7 parts by weight of bis-ethylhexyloxyphenol methoxyphenyl triazine (“TINOSORB S” manufactured by BASF SE) as an ultraviolet absorber in addition to the photopolymerization initiator and the silane coupling agent. The pressure sensitive adhesive composition solution was applied onto a separator, and polymerized to obtain a pressure sensitive adhesive sheet L having a thickness of 100 μm.

The compositions of the pressure sensitive adhesives in the pressure sensitive adhesive sheets A, B, C, D, K and L and the (thickness D, water-vapor permeability X, and transmittance at a wavelength of 380 nm) are summarized in Table 1.

TABLE 1

| | | Cell-side | | | | Viewing-side | |
|---|---|---|---|---|---|---|---|
| | | A | B | C | D | K | L |
| Composition of | BA | 80 | 95 | — | — | — | — |
| base polymer | PEA | 16 | — | — | — | — | — |
| | 2EHA | — | — | 22 | — | 67 | 67 |
| | LA | — | — | 62 | — | — | — |
| | HEA | — | — | — | — | 18 | 18 |
| | 4HBA | 0.8 | — | 8 | — | — | — |
| | NVP | 3 | — | 10 | — | 15 | 15 |
| | AA | 0.2 | 5 | — | — | — | — |
| | PIB | — | — | — | 100 | — | — |
| | TMPTA | — | — | — | — | 0.2 | 0.2 |
| Crosslinker | TAKENATE D110N | 0.3 | 0.3 | 0.3 | — | — | — |
| Silane coupling agent | KBM-400 | — | — | — | — | 0.3 | 0.3 |
| Ultraviolet absorber | TINOSORB S | — | — | — | — | — | 0.7 |
| Thickness D | [μm] | 20 | 20 | 20 | 20 | 100 | 100 |
| Water-vapor | [g/m² · 24 h] | 3100 | 3200 | 1800 | 25 | 660 | 660 |
| permeability X | | | | | | | |
| Transmittance at | [%] | 91 | 91 | 91 | 91 | 91 | 6 |
| 380 nm | | | | | | | |

[Preparation of Thin Polarizer]

One surface of an amorphous polyester film (polyethylene-terephthalate/isophthalate; glass transition temperature: 75° C.) having a thickness of 100 μm was subjected to corona treatment, and an aqueous solution containing polyvinyl alcohol (polymerization degree: 4200, saponification degree: 99.2 mol %) and acetoacetyl-modified polyvinyl alcohol (“GOHSEFIMER Z200” manufactured by Nippon Synthetic Chemical Industry Co., Ltd.; polymerization degree: 1200, acetoacetyl modification degree: 4.6%, saponification degree: 99.0 mol % or more) at a weight ratio of 9:1 was applied to the corona-treated surface at 25° C., and dried to prepare a laminate in which a 11 μm-thick PVA-based resin layer is disposed on an amorphous polyester film base.

The laminate was subjected to free-width uniaxial stretching at a ratio of 2.0 in the longitudinal direction in an oven at 120° C. The stretched laminate was immersed in a 4% boric acid aqueous solution at 30° C. for 30 seconds, and then immersed in a dyeing solution (0.2% iodine, 1.0% potassium iodide aqueous solution) at 30° C. for 60 seconds. The laminate was then immersed in a crosslinking solution at 30° C. (aqueous solution having 3% of potassium iodide and 3% of boric acid) for 30 seconds. Thereafter, the laminate was subjected to width-free uniaxial stretching in the longitudinal direction at a total stretch ratio of 5.5 while being immersed in an aqueous solution having 4% of boric acid and 5% of potassium iodide at 70° C. Thereafter, the laminate was immersed in a cleaning liquid (4% potassium iodide aqueous solution) at 30° C. to obtain a laminate in which a 5 μm-thick PVA-based polarizer is disposed on an amorphous polyester film base.

[Preparation of Single-Side-Protected Polarizing Plate]

<Polarizing Plate A>

40 parts by weight of N-hydroxyethyl acrylamide (HEAA), 60 parts by weight of acryloyl morpholine (ACMO) and 3 parts by weight of a photopolymerization initiator (“IRGACURE 819” manufactured by BASF SE) were mixed to prepare an ultraviolet-curable adhesive. This adhesive was applied to a surface of the polarizer of the laminate with a thickness of about 1 μm, an acryl-based resin film having a lactone ring structure was bonded thereon as a transparent protective film (thickness: 20 μm, water-vapor permeability: 153 g/m²·24 h), and an ultraviolet ray was applied with an integrated irradiation amount of 1000/mJ/cm² to cure the adhesive. Thereafter, the amorphous polyester film base was peeled off to obtain a single-side-protected polarizing plate A with an acryl-based transparent protective film bonded to one surface of a 5 μm-thick thin polarizer with an adhesive interposed therebetween.

<Polarizing Plate B>

A single-side-protected polarizing plate B was obtained in the same manner as described above except that as a transparent protective film, a cyclic polyolefin film (thickness: 20 μm, water-vapor permeability: 20 g/m²·24 h) was bonded to the polarizer in place of the acryl-based resin film.

<Polarizing Plate C>

A single-side-protected polarizing plate C was obtained in the same manner as described above except that as a transparent protective film, a triacetyl cellulose film (thickness: 25 μm, water-vapor permeability: 600 g/m²·24 h) was bonded to the polarizer in place of the acryl-based resin film.

[Preparation of Pressure Sensitive Adhesive-Equipped Polarizing Plate]

### Example 1

A 75% ethyl acetate solution of an isocyanate-terminated urethane prepolymer including a tolylene diisocyanate trimer adduct of trimethylolpropane (“CORONATE L” manufactured by TOSOH CORPORATION) was applied onto the polarizer of the single-side-protected polarizing plate A by a bar coater, and then heated at 60° C. for 12 hours to form a urethane resin layer having a thickness of 0.3 μm. By a roll laminator, the pressure sensitive adhesive sheet A as a cell-side pressure sensitive adhesive sheet was bonded onto the urethane resin layer, and the pressure sensitive adhesive sheet K as a viewing-side pressure sensitive adhesive sheet was bonded onto a transparent protective film to prepare a both sides pressure sensitive adhesive-equipped polarizing plate.

### Examples 2 and 3

In place of the single-side-protected polarizing plate A, the single-side-protected polarizing plate B was used in Example 2, and the single-side-protected polarizing plate C was used in Example 3. A both sides pressure sensitive adhesive-equipped polarizing plate was prepared in the same manner as in Example 1 except above.

### Examples 4 and 5

A both sides pressure sensitive adhesive-equipped polarizing plate was prepared in the same manner as in Example 1 except that the thickness of the urethane resin layer on the polarizer was changed to 1 μm in Example 4 and to 3 μm in Example 5.

### Example 6

A both sides pressure sensitive adhesive-equipped polarizing plate was prepared in the same manner as in Example 1 except that as a cell-side pressure sensitive adhesive sheet, the pressure sensitive adhesive sheet B was bonded onto the urethane resin layer in place of the pressure sensitive adhesive sheet A.

### Example 7

A both sides pressure sensitive adhesive-equipped polarizing plate was prepared in the same manner as in Example 1 except that as a cell-side pressure sensitive adhesive sheet, the pressure sensitive adhesive sheet C was bonded onto the urethane resin layer in place of the pressure sensitive adhesive sheet A.

### Example 8

A urethane resin layer having a thickness of 0.3 μm was formed on the polarizer of the single-side-protected polarizing plate A in the same manner as in Example 1. Thereafter, using a roll laminator, the pressure sensitive adhesive sheet L as a viewing-side pressure sensitive adhesive sheet was bonded onto the urethane resin layer, and the pressure sensitive adhesive sheet A as a cell-side pressure sensitive adhesive sheet was bonded onto a transparent protective film to prepare a both sides pressure sensitive adhesive-equipped polarizing plate.

### Comparative Example 1

A urethane resin layer was not formed on the single-side-protected polarizing plate A. Using a roll laminator, the pressure sensitive adhesive sheet A was bonded onto a polarizer, and the pressure sensitive adhesive sheet K was bonded onto a transparent protective film to prepare a both sides pressure sensitive adhesive-equipped polarizing plate.

### Comparative Example 2

A both sides pressure sensitive adhesive-equipped polarizing plate was prepared in the same manner as in Example 1 except that the thickness of the urethane resin layer on the polarizer was changed to about 0.05 μm.

### Comparative Example 3

A both sides pressure sensitive adhesive-equipped polarizing plate was prepared in the same manner as in Example 1 except that the pressure sensitive adhesive sheet C was bonded onto the urethane resin layer in place of the pressure sensitive adhesive sheet A.

### Comparative Example 4

An aqueous solution of polyvinyl alcohol (polymerization degree: 2400, saponification degree: 99% or more) was applied onto the polarizer of the single-side-protected polarizing plate A by a bar coater, and then heated at 90° C. for 5 minutes to form a PVA resin layer having a thickness of 0.5 μm. Using a roll laminator, the pressure sensitive adhesive sheet A was bonded onto the PVA resin layer, and the pressure sensitive adhesive sheet K was bonded onto a transparent protective film to prepare a both sides pressure sensitive adhesive-equipped polarizing plate.

[Evaluation of Heating and Humidification Durability]

The both sides pressure sensitive adhesive-equipped polarizing plate was cut to a size of 200 mm×140 mm, the separator on the cell-side pressure sensitive adhesive sheet (pressure sensitive adhesive sheet A, B or C) was separated, and a glass plate (280 mm×180 mm×0.7 mm) was then bonded to the exposed surface of the pressure sensitive adhesive sheet using a hand roller. Thereafter, the separator on the viewing-side pressure sensitive adhesive sheet (pressure sensitive adhesive sheet K or L) was separated, and a glass plate (280 mm×180 mm×0.7 mm) was placed on the exposed surface of the pressure sensitive adhesive sheet, and press-bonded to the pressure sensitive adhesive sheet by a vacuum press bonding device (device internal pressure: 30 Pa, bonding surface pressure: 0.3 MPa, bonding time: 5 seconds). Thereafter, an autoclave treatment was performed (temperature: 50° C., pressure: 0.5 MPa, time: 15 minutes). In this way, a panel for evaluation in which a glass plate bonded to each of both surfaces of a single-side-protected polarizing plate with a pressure sensitive adhesive sheet interposed therebetween was obtained.

(Color Loss at End Portion)

The panel for evaluation was put in a thermohygrostat bath at 60° C. and a relative humidity of 95%, left standing for 240 hours, and then taken out. The polarizing plate of the panel for evaluation and a standard polarizing plate (polarization degree: 99.995%) were arranged in a cross nicol state, the vicinity of a corner of the polarizing plate of the panel for evaluation was observed with an optical microscope (“MX 61 L” manufactured by Olympus Corporation, magnification: 10 times), and the width of a region having a color loss (the distance from the end portion of the polarizing plate) was measured.

(Optical Characteristics at Central Portion)

The single transmittance and the cross transmittance at the central portion in the surface of the panel for evaluation were measured. The transmittance is a Y value obtained by performing visibility correction with a 2-degree visual field (C light source) in JIS Z8701. The polarizing plate of the panel for evaluation and the standard polarizing plate were arranged in a cross nicol state, and the cross transmittance was measured. The panel for evaluation after measurement of the single transmittance and the cross transmittance was put in a thermohygrostat bath at 60° C. and a relative humidity of 95%, left standing for 500 hours, and then taken out. The cross transmittance P and the single transmittance T of the panel for evaluation were measured, and changes from the cross transmittance and the single transmittance before putting the panel in the thermohygrostat bath (ΔT and ΔP) were calculated.

[Evaluation Results]

The configurations of the both sides pressure sensitive adhesive-equipped polarizing plates in Examples and Comparative Examples, and evaluation results after the heating and humidification durability test are shown in Table 2.

TABLE 2

| | | | Example | Example | Example | Example | Example | Example | Example |
|---|---|---|---|---|---|---|---|---|---|
| | | | 1 | 2 | 3 | 4 | 5 | 6 | 7 |
| Viewing-side pressure | | Type | K | K | K | K | K | K | K |
| sensitive adhesive | | Thickness D [μm] | 100 | 100 | 100 | 100 | 100 | 100 | 100 |
| sheet | | Water-vapor permeability X | 660 | 660 | 660 | 660 | 660 | 660 | 660 |
| | | [g/m2 · 24 h] | | | | | | | |
| | | XD² [×10⁻⁷ g/24 h] | 66 | 66 | 66 | 66 | 66 | 66 | 66 |
| | | XD [×10⁻³ g/m · 24 h] | 66 | 66 | 66 | 66 | 66 | 66 | 66 |
| | | Transmittance at 380 nm | 91 | 91 | 91 | 91 | 91 | 91 | 91 |
| Polarizing | Protective | Arrangement | Viewing- | Viewing- | Viewing- | Viewing- | Viewing- | Viewing- | Viewing- |
| plate | film | | side | side | side | side | side | side | side |
| | | Resin type | Acrylic | COP | TAC | Acrylic | Acrylic | Acrylic | Acrylic |
| | | Thickness [μm] | 20 | 20 | 25 | 20 | 20 | 20 | 20 |
| | | Water-vapor permeability | 153 | 20 | 600 | 153 | 153 | 153 | 153 |
| | | [g/m2 · 24 h] | | | | | | | |
| | | Transmittance at 380 nm | 25 | 8 | 11 | 25 | 25 | 25 | 25 |
| | Resin | Composition | Urethane | Urethane | Urethane | Urethane | Urethane | Urethane | Urethane |
| | layer | Thickness [mm] | 0.3 | 0.3 | 0.3 | 1 | 3 | 0.3 | 0.3 |

| Cell-side pressure | Type | | A | A | A | A | A | B | C |
|---|---|---|---|---|---|---|---|---|---|
| sensitive adhesive | Thickness D [mm] | | 20 | 20 | 20 | 20 | 20 | 20 | 20 |
| sheet | Water-vapor permeability X | | 3100 | 3100 | 3100 | 3100 | 3100 | 3200 | 1800 |
| | [g/m2 · 24 h] | | | | | | | | |
| | XD² [×10⁻⁷ g/24 h] | | 12.4 | 12.4 | 12.4 | 12.4 | 12.4 | 12.8 | 7.2 |
| | XD [×10⁻² g/m · 24 h] | | 62 | 62 | 62 | 62 | 62 | 64 | 36 |
| Durability | Color loss at end portion [μm] | | 300 | 240 | 310 | 320 | 290 | 560 | 260 |
| (60° C. 95% RH) | Change in | ΔT [%] | +0.9 | +1.0 | +1.1 | +1.0 | +1.0 | +1.7 | +1.1 |
| | characteristics at | ΔP [%] | 0 | 0 | 0 | 0 | 0 | −0.3 | 0 |
| | central portion | | | | | | | | |

| | | | Example | Comparative | Comparative | Comparative | Comparative |
|---|---|---|---|---|---|---|---|
| | | | 8 | Example 1 | Example 2 | Example 3 | Example 4 |
| Viewing-side pressure | | Type | L | K | K | K | K |
| sensitive adhesive | | Thickness D [μm] | 100 | 100 | 100 | 100 | 100 |
| sheet | | Water-vapor permeability X | 660 | 660 | 660 | 660 | 660 |
| | | [g/m2 · 24 h] | | | | | |
| | | XD² [×10⁻⁷ g/24 h] | 66 | 66 | 66 | 66 | 66 |
| | | XD [×10⁻³ g/m · 24 h] | 66 | 66 | 66 | 66 | 66 |
| | | Transmittance at 380 nm | 6 | 91 | 91 | 91 | 91 |
| Polarizing | Protective | Arrangement | Cell- | Viewing- | Viewing- | Viewing- | Viewing- |
| plate | film | | side | side | side | side | side |
| | | Resin type | Acrylic | Acrylic | Acrylic | Acrylic | Acrylic |
| | | Thickness [μm] | 20 | 20 | 20 | 20 | 20 |
| | | Water-vapor permeability | 153 | 153 | 153 | 153 | 153 |
| | | [g/m2 · 24 h] | | | | | |
| | | Transmittance at 380 nm | 25 | 25 | 25 | 25 | 25 |
| | Resin | Composition | Urethane | | Urethane | PVA | Urethane |
| | layer | Thickness [mm] | 0.3 | | 0.05 | 0.5 | 0.3 |

| Cell-side pressure | Type | | B | A | A | A | D |
|---|---|---|---|---|---|---|---|
| sensitive adhesive | Thickness D [mm] | | 20 | 20 | 20 | 20 | 20 |
| sheet | Water-vapor permeability X | | 3100 | 3100 | 3100 | 3100 | 25 |
| | [g/m2 · 24 h] | | | | | | |
| | XD² [×10⁻⁷ g/24 h] | | 12.4 | 12.4 | 12.4 | 12.4 | 0.1 |
| | XD [×10⁻² g/m · 24 h] | | 62 | 62 | 62 | 62 | 0.5 |
| Durability | Color loss at end portion [μm] | | 280 | 2600 | 710 | 2300 | 280 |
| (60° C. 95% RH) | Change in | ΔT [%] | +1.4 | +10.2 | +2.7 | +8.8 | +3.2 |
| | characteristics at | ΔP [%] | 0 | −5.5 | −1.2 | −4.5 | −0.1 |
| | central portion | | | | | | |

In Example 1 using a single-side-protected polarizing plate in which a cured product layer of a urethane prepolymer having a thickness of 0.3 μm was formed on a protective film-free surface of the polarizer, the polarizing plate had a small color loss at an end portion after the heating and humidification durability test, the polarizing plate had a small change in optical characteristics at an in-plane central portion, and favorable durability was exhibited. In Example 2 using a cyclic polyolefin film as a polarizer protective film of the single-side-protected polarizing plate and Example 3 using a cellulose-based film, favorable durability was exhibited as in the case of Example 1. In Examples 4 and 5 where the urethane layer on the polarizer had a large thickness, favorable durability was exhibited as in the case of Example 1.

On the other hand, in Comparative Example 1 where a cell-side pressure sensitive adhesive sheet was disposed on the polarizer without a urethane layer interposed therebetween, the polarizing plate had a considerably increased color loss at an end portion after the heating and humidification durability test. In addition, the polarizing plate had an increased single transmittance and a reduced polarization degree at an in-plane central portion, which is associated with a moisture-caused degradation of the polarizer.

In Comparative Example 2 where a urethane layer having a thickness of 0.05 μm was disposed on the polarizer, the color loss at an end portion of the polarizing plate and a change in optical characteristics at an in-plane central portion of the polarizing plate were suppressed as compared with Comparative Example 1, but marked degradation occurred as compared to Examples. In Comparative Example 3 where in place of the urethane layer, a PVA-based resin layer was disposed on the polarizer, the polarizing plate was degraded after the heating and humidification durability test as in Comparative Example 1.

These results show that the durability of the single-side-protected polarizing plate can be considerably improved by disposing the pressure sensitive adhesive sheet on the polarizer with a urethane layer interposed therebetween with a specific thickness.

On the other hand, in Comparative Example 4 where the rubber-based pressure sensitive adhesive sheet D was disposed as a cell-side pressure sensitive adhesive sheet on the urethane layer, the color loss at an end portion of the polarizing plate was suppressed after the heating and humidification durability test, but the change in single transmittance at a central portion exceeded 3%. This may be because the pressure sensitive adhesive sheet D had low water-vapor permeability, moisture was hardly dissipated from the pressure sensitive adhesive sheet even when a urethane layer was formed, and the polarizer was degraded due to the retention of moisture.

In Example 6 where the pressure sensitive adhesive sheet B was used as a cell-side pressure sensitive adhesive sheet on the urethane layer, the polarizing plate had a larger color loss amount as compared to other Examples. This may be because the pressure sensitive adhesive sheet B, which is almost the same as the pressure sensitive adhesive sheet A in water-vapor permeability, has a high content of an organic acid (acrylic acid) in a monomer component that forms the base polymer, and a remaining acid monomer is easily transferred to the polarizer under a heated and humidified environment.

In Example 7 where the pressure sensitive adhesive sheet C, in place of the pressure sensitive adhesive sheet A, was disposed on the urethane layer, favorable durability was exhibited as in the cases of Examples 1 to 5. In addition, in Example 8 where a polarizer protective film-free surface of the single-side-protected polarizing plate was arranged on the cell-side, and the pressure sensitive adhesive sheet L as a viewing-side pressure sensitive adhesive sheet was disposed on the urethane layer, favorable durability was exhibited as in the cases of other Examples.

The above results show that durability in a heated and humidified environment can be improved when a urethane layer having a specific thickness is formed on a polarizer protective film-free surface of the single-side-protected polarizing plate, and a pressure sensitive adhesive sheet having high water-vapor permeability is disposed on the urethane layer.

What is claimed is:

1. A pressure sensitive adhesive-equipped polarizing plate, comprising:
a polarizing plate containing a polyvinyl alcohol-based polarizer; and
a first pressure sensitive adhesive sheet arranged on one principal surface of the polarizing plate, wherein
the polarizer has a first principal surface and a second principal surface,
a transparent protective film is bonded to the second principal surface of the polarizer,
a urethane layer having a thickness of 0.1 to 10 μm is disposed in contact with the first principal surface of the polarizer,
the first pressure sensitive adhesive sheet is disposed in contact with the urethane layer, and
a value XD² of the first pressure sensitive adhesive sheet is 1×10⁻⁷ g/24 h or more, where X is a water-vapor permeability of the first pressure sensitive adhesive sheet, and D is a thickness of the first pressure sensitive adhesive sheet.

2. The pressure sensitive adhesive-equipped polarizing plate according to claim 1, wherein a value XD of the first pressure sensitive adhesive sheet is 1×10⁻² g/m·24 h or more, where X is a water-vapor permeability of the first pressure sensitive adhesive sheet, and D is a thickness of the first pressure sensitive adhesive sheet.

3. The pressure sensitive adhesive-equipped polarizing plate according to claim 1, wherein the first pressure sensitive adhesive sheet contains 50% by weight or more of an acryl-based polymer.

4. The pressure sensitive adhesive-equipped polarizing plate according to claim 3, wherein an amount of acid monomer components is 1 part by weight or less based on 100 parts by weight of the total of constituent monomer components of the acryl-based polymer.

5. The pressure sensitive adhesive-equipped polarizing plate according to claim 1, wherein no hard coat layer is provided on a surface of the transparent protective film.

6. The pressure sensitive adhesive-equipped polarizing plate according to claim 1, wherein the polarizer has a thickness of 10 μm or less

7. The pressure sensitive adhesive-equipped polarizing plate according to claim 1, wherein a second pressure sensitive adhesive sheet is disposed on the transparent protective film.

8. The pressure sensitive adhesive-equipped polarizing plate according to claim 7, wherein the second pressure sensitive adhesive sheet contains 50% by weight or more of an acryl-based polymer.

9. The pressure sensitive adhesive-equipped polarizing plate according to claim 7, wherein the first pressure sensitive adhesive sheet serves as a pressure sensitive adhesive for bonding the polarizing plate to an image display cell, and the second pressure sensitive adhesive sheet serves as a pressure sensitive adhesive for bonding the polarizing plate to a front transparent plate or touch panel.

10. The pressure sensitive adhesive-equipped polarizing plate according to claim 9, wherein a thickness of the first pressure sensitive adhesive sheet is smaller than a thickness of the second pressure sensitive adhesive sheet.

11. The pressure sensitive adhesive-equipped polarizing plate according to claim 7, wherein the first pressure sensitive adhesive sheet serves as a pressure sensitive adhesive for bonding the polarizing plate to a front transparent plate or touch panel, and the second pressure sensitive adhesive sheet serves as a pressure sensitive adhesive for bonding the polarizing plate to an image display cell.

12. The pressure sensitive adhesive-equipped polarizing plate according to claim 11, wherein a thickness of the second pressure sensitive adhesive sheet is smaller than a thickness of the first pressure sensitive adhesive sheet.

13. The pressure sensitive adhesive-equipped polarizing plate according to claim 12, wherein a light transmittance of the first pressure sensitive adhesive sheet at a wavelength of 380 nm is 30% or less.
